(19) United States
(12) Patent Application Publication
(10) Pub. No.: US 2010/0076814 A1
(43) Pub. Date: Mar. 25, 2010

(54) METHOD FOR FINANCIAL FORECASTING FOR ASSOCIATIONS USING ACTUARIAL OPEN GROUP SIMULATION

(76) Inventor: Kathleen E. Manning, Chicago, IL (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/237,071

(22) Filed: Sep. 24, 2008

(51) Int. Cl. G06F 17/30; G06Q 40/00

(52) U.S. Cl. 705/10; 705/40; 705/35

(57) ABSTRACT

In a method for financial forecasting for an association having current dues paying members and which will have future new dues paying members, a computer and a computer-readable medium are provided having a program operable with the computer. Association variables to be forecast are defined as desired program outputs and including for each of a plurality of periods at least total dues revenue. A total number of the current members, dues paid by each current member, at least one of actual age or estimated age of each current member, and a future dues predictor variable are input to the program. Using at least the actual or estimated age of each current member, it is projected when each of the current members would have a change in dues paying status or would no longer be a member of the association. Using a defined growth rate characteristic for the association, for each of the periods a number of the new dues paying members is projected which will join the association. For each of the projected new members, at least an age for each of the new members and dues for each of the new members based on the future dues predictor variable are projected. It is also projected when each new member would have a change in dues paying status or would no longer be a member of the association. From the inputs the program calculates the desired outputs for each of the periods.

### BACKGROUND

Associations, which include affinity group enterprises such as clubs, depend upon their existing and potential future membership for their revenue. Statisticians for associations sometimes forecast (based upon census demographics) the supply of professionals for serving the general populations, but do not forecast the single and multivariate effect of demographic changes and other membership structural changes upon long term revenue and the overall financials of the organization.

### SUMMARY

It is an object to provide financial forecasting for associations which take into consideration both existing and potential future membership.

In a method for financial forecasting for an association having current dues paying members and which will have future new dues paying members, a computer and a computer-readable medium are provided having a program operable with the computer. Association variables to be forecast are defined as desired program outputs and including for each of a plurality of periods at least total dues revenue. A total number of the current members, dues paid by each current member, at least one of actual age or estimated age of each current member, and a future dues predictor variable are input to the program. Using at least the actual or estimated age of each current member, it is projected when each of the current members would have a change in dues paying status or would no longer be a member of the association. Using a defined growth rate characteristic for the association, for each of the periods a number of the new dues paying members is projected which will join the association. For each of the projected new members, at least an age for each of the new members and dues for each of the new members based on the future dues predictor variable are projected. It is also projected when each new member would have a change in dues paying status or would no longer be a member of the association. From the inputs the program calculates the desired outputs for each of the periods.

### BRIEF DESCRIPTION OF THE DRAWINGS

FIGS. 1A, 1B and 1C is a flowchart of the method for financial forecasting for associations according to the preferred embodiment.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, such alterations and further modifications in the illustrated method, and such further applications of the principles of the invention as illustrated therein being contemplated as would normally occur to one skilled in the art to which the invention relates.

The demographic impact of the aging “baby boomer” will affect affinity organizations significantly. Membership and other components of such entities will be significantly affected by the demographic changes spanning the next ten to twenty years. The computer programmed method of the preferred embodiment anticipates and measures the effects of these and other changes upon the financial operations of these entities.

The computer programmed method applies multiple decrement and multiple variable forecasting models of actuarial open group methodologies to predict and forecast short and long term illustrations of revenue, expense and other financial components or categories. The analysis portrays significant financial components by period, and illustrates the sensitivities of annual results to specific changes in the selected assumptions. The open group aspect means that the programmed method considers not only the current existing population, but “opens” the population to future “entrants” at each period in the future of the projections by simulating the additions to the group. To the contrary, a “closed” group projection would only project information about a diminishing group. But the “open” group projection adds hypothetical new entrants based upon profiles which reflect the anticipated characteristics and number of new members.

Actuarial methodologies take account of mortality for individual members, as well as lapse or termination rates (from membership) of individual members due to various decrements including disability, voluntary withdrawal, retirement etc. To project annual revenue, the programmed method incorporates the aging of the current membership along with the inclusion of simulated new members. The projected changes in dues (and ultimate Association revenue) associated with changes in membership status as a result of retirement, disability etc. is forecasted as the member is exposed to various potential decrements. The projected dues revenue from new and returning members is also forecasted according to new entrant profiles developed by industry or through entity experience. The projected dues revenue is projected with inflationary components and also reflects future dues structural changes. The non-dues revenue is also forecasted based upon correlations with membership and other services, in accordance with the long term strategic plans of the entity.

The forecasting programmed method develops the number of new members required to maintain an increasing, decreasing or constant active membership number, which is further compared with available sources of members based upon various census and demographic information such as projected college graduates each year. The population and member projections are limited by area as well as other factors, depending upon the relevance of the criteria to the entity.

The revenue associated with these changes is projected and modeled with sensitivities based upon many different assumptions, or assumption sets, to predict future income. Similarly, associated annual (or periodic) expense is projected. As a by-product of the method, the projections measure the replacement membership required under the various simulations. Measuring such a component permits entities to explore the sources available and targets for new membership and to develop strategies for meeting new membership goals or creating alternative revenue sources.

The method of the preferred embodiment takes into account the following variables, some of which may not be available or used:
Current Membership: Age, Date of Entry into Membership, Professional status, Membership status (active, retired, disabled etc. depending upon organizational descriptions), Dues schedules of members, requirements for entry into the organization (professional credentials, etc., geographical location, nature of employer of member,); and
Actuarial Factors: existing membership populations are exposed to decrements according to assumptions regarding annual rates of mortality, annual rates of disability, annual rates of lapse in membership, annual rates of retirement, rates of inflation.

Future new entrants into the population (new or reentering prior Members) are simulated and added to the population projections annually based upon the new entrant profiles developed from industry or entity historical information (with modifications for change expectations).

The required new member replacements as measured and indicated through simulations of the programmed method of the preferred embodiment are compared with projections of population and demographic information from sources such as latest census, survey information, educational systems' information and publications, entity specific surveys and information and other private and publicly available demographic sources and estimates.

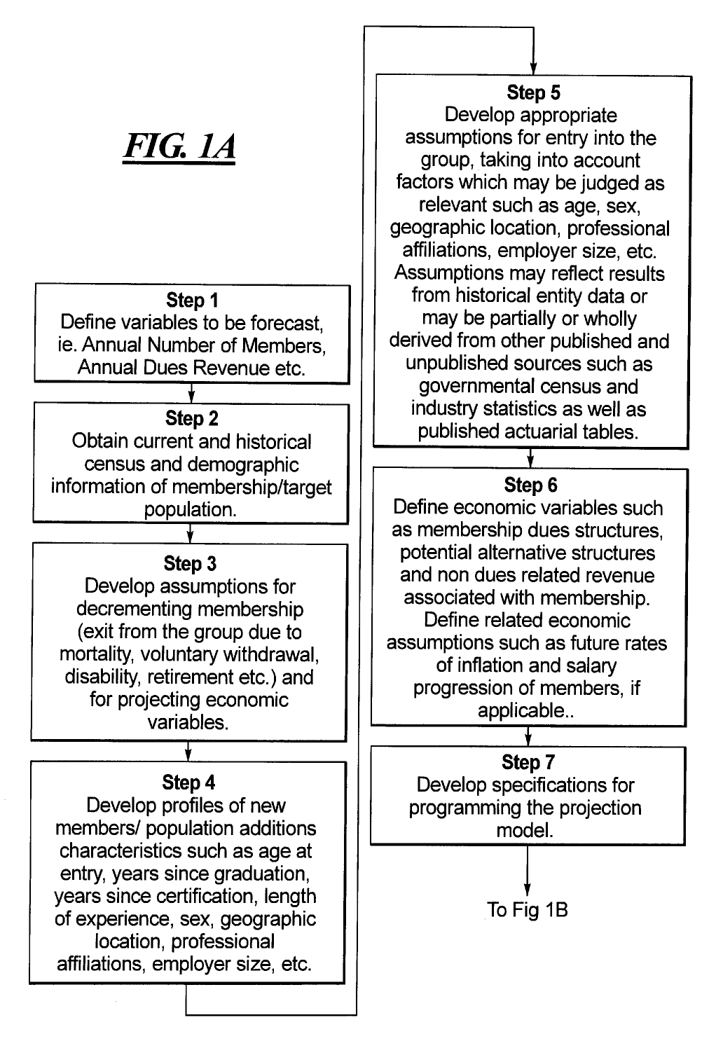

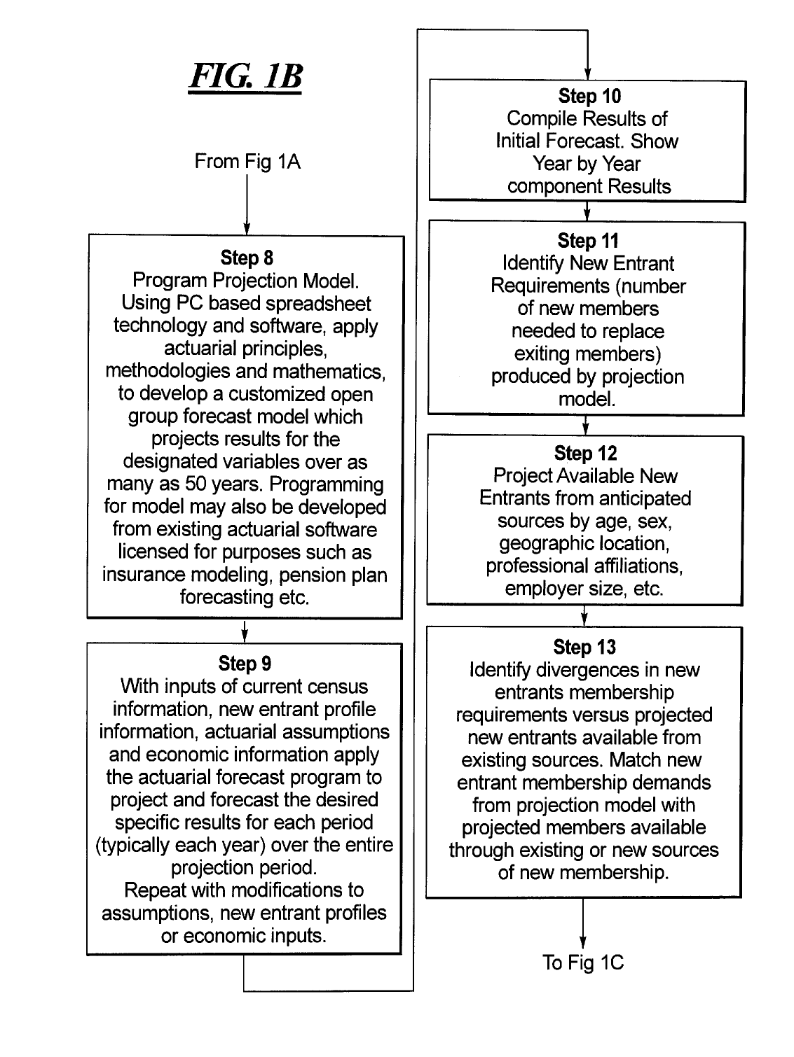

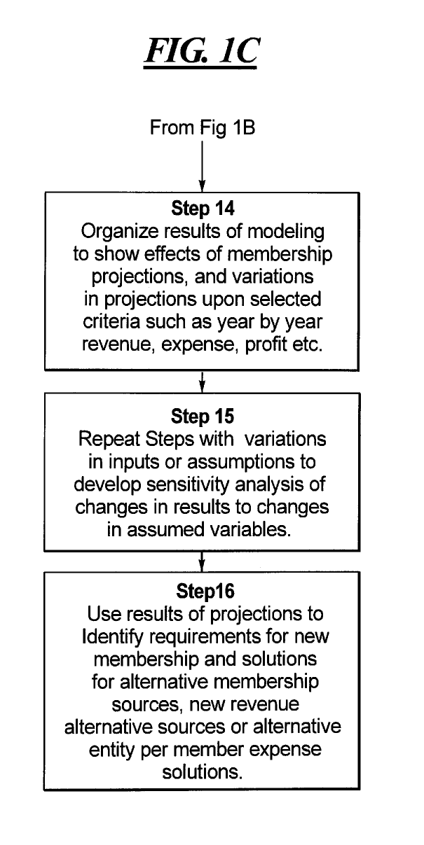

Method steps of the computer program (flowchart) will now be described with reference to Steps 1-16 of FIGS. 1A-1C.

### Develop/Define Criteria and Desired Output for Projection

The variables to be measured are developed, i.e. Membership totals by year, number exiting by source, number entering, demographic characteristics of membership by year, dues related annual revenue, Non dues annual Revenue, Membership related expenses, etc. As shown in the drawing FIG. 1A under Step 1, this first step requires definition of the items (variables) to be forecast (the outputs) such as the number of members by membership status, the annual revenues (i.e. dues paid by members).

### Inputs

As shown in Step 2 of FIG. 1A, data, demographic and other information regarding the current membership population, historical statistics, and entity historical information such as dues etc. must be collected.
Existing Membership Census Information (Dates of Birth, Sex, Locations etc.)
Existing and Alternative Annual Dues Structure of Organization
Historical Statistics regarding membership (if available)
Published and Unpublished Actuarial, Census and Demographic information
Entity expense per member, or per other defined unit to be projected as part of the model.

### Develop/Select Actuarial Assumptions

As shown in Step 3 of the flow chart, probabilities are developed for specific occurrences (i.e. death, retirement, membership lapse, disability, etc.) or selected based upon the data and information gathered in Step 2. Using historical data from Step 2 sourced from the entity and using information from other statistical and demographic sources, annual rates/probabilities are developed for decrements to be used in the actuarial assumptions such as those with respect to membership lapse/termination from the group by source such as from death, retirement, disability, voluntary withdrawal, etc. These annual decrement rates are applied to the existing population and to the new entrant simulated population. Assumptions reflect entity data exclusively or are partially or wholly derived from other published and unpublished sources such as governmental census and industry statistics as well as published actuarial tables.

Actuarial Assumptions i.e.:
Rates of Mortality by Age, Sex, Profession etc. (may be custom or standard tables)
Rates of Termination from Entity by age/sex/ duration of membership (may be custom or standard tables)
Rates of Disability by age/sex (may be custom or standard tables)
Rates of Retirement by age/sex (may be custom or standard tables)
Rates of Increase in Dues Structures from inflation
Rates of Increase in Dues from other factors

### Develop New Entrant Profiles

As shown in FIG. 1A under Step 4, selected characteristics such as age, sex, experience, geographic location etc., of new members (new entrants) must be developed as part of the projection. These new members are “synthetic” or hypothetical members and are introduced statistically into the membership population according to the specifications regarding whether the group is to grow, remain stable, diminish or simply replace exiting members. The characteristics of the new entrants are narrowly defined or expanded depending upon the project objectives. These new entrants
the new entrant profile—define the additions to the group according to the frequency assigned to the characteristic profiles, i.e. of the new members, 10% are female age 20 earning 80,000 in 2008, and so on. As shown in the FIG. 1A under Step 5, as individuals are projected to leave the membership due to any of the decrements assumed and identified in the programmed method, some level of new members is required to maintain the membership. The membership projection assumptions are specified to be increasing or decreasing at a specific rate or remain static under the method. The program develops the number of new entrants required each year in order to satisfy the criteria of either a static, increasing or decreasing membership. The new entrant members are simulated according to assumed characteristics and replace the exiting members. The characteristics of the New Entrants or New Members into the group are developed as part of the programmed method assumptions and as described above include such features as the age, sex, and geographic location or other information as pertinent to the method. New entrant profiles reflect characteristics of historical new members or reflect an anticipated set of characteristics for projected new members.

New Entrant Profiles
Percentage of new members entering group each year categorized demographically. Characteristics such as age at entry, years since graduation, years since certification, length of experience, sex, geographic location, professional affiliations, employer size, etc. are included.
Basic characteristics may reflect existing characteristics of membership or may incorporate different characteristics.

Define/Develop Economic Variables

As shown in FIG. 1A under Step 6, non-demographic variables integral to the method are developed. Economic variables such as membership dues structures, potential alternative structures and non-dues related revenue associated with membership are defined. For example, an association may structure annual dues according to several classifications such as age, professional status or designation or credentials, or other status such as retired or disabled. These structures are subject to modification (usually at least inflationary increases) as well as other changes which are included as alternative structures in the method. In addition related economic assumptions such as future rates of inflation and salary progression of members, if applicable, are defined.

### Develop Specifications for Projection Method.

As shown in Step 7, the specifications for the projection method are developed. This step includes enumerating and specifying the elements which have been identified as required as inputs for the program such as the member census information, the revenue structure components etc. and what components and values are to be calculated to provide the results of the forecast, for the specified number of years. Program Actuarial Open Group Forecasting Method for Forecast Periods As shown in Step 8 of FIG. 1B, using known PC based spreadsheet technology and software, actuarial principles, methodologies and mathematics are to develop a customized method which uses the specifications of Step 7 and assumptions and inputs developed under steps 1 through 6, to calculate and project the results for the designated variables.

The methodology combines the decrementing of the current membership according to periodic (assumed annual) individual application of the assumed probabilities of decrements (death, disability etc,) and the incrementing of the projected population with simulated new members having the characteristics according to the assumptions of the new entrant profiles. The simulated new members exactly replace the exiting members or are programmed to produce an increasing or decreasing membership population.

Programming for the method is also developed from existing actuarial software licensed for purposes such as insurance modeling, pension plan forecasting etc.—up to 50 year forecasts of year by year membership including annual number of existing members, annual members exiting and entering group, annual dues and non dues related revenue, selected expense components, other items as required

### Apply Program to Inputs as Specified

As shown in Step 9, once the programmed method accepts the customized inputs and selected assumptions designated for the project, the program is executed for the specified number of years. The output and results are retained and this step is repeated with modifications to various inputs such as new entrant profiles, selected actuarial assumptions, or economic inputs etc., retaining the results after each modification.

### Compile Results of Initial Forecast

As shown in Step 10 of FIG. 1C, the results are compiled and output from each of the applications of the program in Step 9, which are thought of as separate scenarios. Identify and summarize the elements of these results: year by year results of revenue, membership and expense components (according to project).

### Identify New Entrant Requirements.

As shown in Step 11, from the output of Steps 9 and 10, the numbers of members entering and exiting the group each year are identified under the various scenarios. The number of new entrants required to sustain membership at criteria levels (increasing, decreasing or static) is provided. Analyze and compare Simulated New Membership Requirements with

### Available Sources for Membership

As shown in Step 12, current and alternative sources of new membership are identified (i.e. existing projections of new graduates from universities, dental schools, etc, or governmental or other demographic and census information). New entrants from these sources are projected by age, sex, geographic location, professional affiliation

As shown in Step 13, divergences in new membership needs are identified from projection versus new membership sources. New entrant membership demands are matched from projections with existing and projected sources of new membership by age, sex, geographic location, professional affiliations, employer size, etc.

### Organize and Summarize Results

As shown in Step 14, the results of the previous steps are organized to show the effects membership projection scenarios have upon the selected criteria for each year in the projection period, such as annual revenue etc.

### Repeat and Refine Model

As shown in Step 15, prior Steps are repeated as necessary or desired to refine inputs or outputs:
provide sensitivity of year by year results to changes in selected assumptions for each component and variable as requested or required; and
repeat projections with modifications to assumptions, new entrant profiles or economic inputs to measure range of results and sensitivities of results to changes in assumptions or input items.
   Use Outcomes from Program

As shown in Step 16, the results and outcomes from the program are used to identify potential issues and problems and to illustrate solutions and strategies for the future of the entity:
to identify annual new membership patterns (increases or decreases in members, status changes, etc.);
to identify the number of new members required to maintain, increase or decrease membership population;
To compare membership requirements with projections of new members from existing sources
To develop potential new sources of new members and the number of such memberships
To develop financial implications such as annual revenue and expense associated with membership projections of entity
To prepare entity for potential precipitous changes in membership or revenue associated with the demographics of their population
To assist the entity in anticipating future financial conditions associated with membership numbers and in developing strategies appropriate to the goals of the entity.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A method for financial forecasting for an association having current dues paying members and which will have future new dues paying members, comprising the steps of:
providing a computer and a computer-readable medium having a program operable with said computer;
defining association variables to be forecast as desired program outputs and including at least for each of a plurality of periods total dues revenue;
inputting to said program at least a total number of said current members, dues paid by each current member, at least one of actual age or estimated age of each current member, and a future dues predictor variable;
using at least the actual age or the estimated age of each current member, projecting when each of the current members would have a change in dues paying status or would no longer be a member of the association;
using a defined growth rate characteristic for the association, also projecting for each said period a number of said new dues paying members projected to join the association, and for each said projected new member projecting at least an age, dues based on said future dues predictor variable, and when the new member would have a change in dues paying status or would no longer be a member of the association;
from said inputs, with said program calculating said desired outputs for each said period; and
outputting said desired outputs.

2. A method of claim 1 wherein said future dues predictor variable comprises inflation rate.

3. A method of claim 1 wherein said future dues predictor variable comprises a schedule of future dues increases.

4. A method of claim 1 wherein variables to be forecast as desired program outputs also include total membership and total expenses for each period.

5. A method of claim 1 wherein also input to the program are expenses associated with each current member.

6. A method of claim 1 wherein also input to said program are at least current association expenses.

7. A method of claim 1 wherein using at least the actual or estimated age of each current member, it is projected when the current member will die, retire from the association, or have said change in dues paying status, and also projecting for each projected new member at least when the projected new member will die, retire from the association, or have said change in dues paying status.

8. A method of claim 1 wherein each of said periods is an annual period of one year.

9. A method of claim 1 wherein current and historical census and demographic information is obtained based on current membership.

10. A method of claim 1 wherein assumptions are provided in the program for decrementing membership based on new and current members leaving the association due to mortality, voluntary withdrawal, disability, or retirement, or said change in dues paying status.

11. A method of claim 1 including developing profiles of said projected new members including in addition to age of each projected new member, at least one of year since graduation, year since certification, length of experience, sex, geographical location, professional affiliations, and employer size.

12. A method of claim 1 wherein assumptions are developed for entry of projected new members into the association taking into account at least one of the age, sex, geographical location, professional affiliations, and employer size.

13. A method of claim 1 wherein non-dues related revenue is also input.

14. A method of claim 1 wherein said defined growth rate characteristic for the association comprises a positive growth rate, a substantially unchanged growth rate, or a negative growth rate.

15. A method of claim 1 including identifying divergences in new projected membership requirements versus projected new members available from existing sources.

16. A method of claim 1 including organizing said outputs to show effects of membership projections and variations in projections.

17. A method of claim 1 including using said outputs for at least one of identifying requirements for new membership, solutions for alternative membership sources, new revenue alternative sources, and alternative entity per member expense solutions.

18. A method for financial forecasting for an association having current dues paying members and which will have future new dues paying members, comprising the steps of:
providing a computer and a computer-readable medium having a program operable with said computer;
defining association variables to be forecast as desired program outputs and including at least for each of a plurality of periods total dues total membership, total dues revenue, and total expenses;
inputting to said program an identification of each of said current members, dues paid by each current member, expenses of the association, and at least one of actual age or estimated age of each current member and a future dues predictor variable;
using at least the actual age or the estimated age of each current member, projecting when each current member would have a change in dues paying status or would no longer be a member of the association;
using a defined growth rate characteristic for the association, also projecting for each said period a number of said new dues paying members projected to enter into the association, and for each said projected new member projecting at least an age, dues for each said new member based on said future dues predictor variable, and when the new member would have a change in dues paying status or would no longer be a member of the association;
from said inputs, with said program calculating said desired outputs for each said period; and
outputting said desired outputs.

19. A method for financial forecasting for an association having current dues paying members and which will have future new dues paying members, comprising the steps of:
providing a computer and a computer-readable medium having a program operable with said computer;
defining association variables to be forecast as desired program outputs and including at least for each of a plurality of periods total membership, total dues revenue, and total expenses;
inputting to said program said current members, dues paid by each current member, expenses associated with each current member, and at least one of actual age or estimated age of each current member, and a future dues predictor variable;
using at least the actual age or the estimated age of each current member, projecting at least death, retirement from the association, or change of dues paying status of each of said current members;
using a defined growth rate characteristic for the association, also projecting for each said period a number of said new dues paying members projected to enter into the association, and for each said projected new member projecting at least an age and dues for each said new member based on said future dues predictor variable, and projecting at least one of death, retirement, or change of dues paying status from or for the association of each of said new members;
from said inputs, with said program calculating said desired outputs for each said period; and
outputting said desired outputs.
